(19) United States
(12) Patent Application Publication
(10) Pub. No.: US 2022/0227314 A1
(43) Pub. Date: Jul. 21, 2022

(54) INNER FACE OF A MOTOR-VEHICLE DOOR

(71) Applicant: K.L. KASCHIER-UND LAMINIER GMBH, Bad Bentheim-Gildehaus (DE)

(72) Inventors: Albert RORING, Gronau-Epe (DE); Rembert SCHULZE WEHNINCK, Tutzing (DE)

(21) Appl. No.: 17/614,968

(22) PCT Filed: Jul. 16, 2019
(86) PCT No.: PCT/EP2020/070075

§ 371 Date: Nov. 29, 2021

(30) Foreign Application Priority Data
Dec. 2, 2019 (DE) 10 2019 132 576.5

(51) Int. Cl. B60R 13/02; B60J 5/04

(52) U.S. Cl. CPC B60R 13/0243; B60J 5/0481; B60J 5/0413; B60J 5/0455

(57) ABSTRACT

The invention relates to an inner face of a motor vehicle door, more particularly the insert, more particularly the trim strip of the inner face, wherein the inner face, the insert or the trim strip has a reinforcement arranged in or on the material, more particularly in or on the plastic of the inner face, of the insert or of the trim strip, said reinforcement consisting of a textile, a metal profile, a metal foil, a plastic profile or a plastic film.

The invention relates to an inner panel of a motor vehicle door, in particular the insert, in particular the trim strip of the inner panel.

It is known to fasten inserts and trim strips made of plastic on the inside of a motor vehicle door. In this case, it has been found that, in the event of an impact on the side surface of a motor vehicle and thus on the motor vehicle door, the insert or the trim strip can break out of plastic and parts of the insert or the trim strip fly into the interior of the motor vehicle and injure the occupants.

The object of the invention is to improve the inside of a motor-vehicle door and/or the insert or, for example, a plastic trim strip on the inner panel of a motor vehicle door in such a way that, in the event of a load on the trim strip, in particular by a side impact, this trim trim strip does not break into individual components, but either does not break apart or does not fragment when breaking.

This object is attained according to the invention by providing the inner panel, the insert or the trim strip with a reinforcement arranged in or on the material, in particular in or on the plastic of the inner panel, of the insert or of the trim strip constuted by a textile, a metal profile, a metal foil, a plastic profile or a plastic film.

This reinforcement prevents breaking of the insert or the trim strip in particular when the insert/the trim strip is subjected to a load, such as in the case of a side impact, so that the insert/trim strip or parts of the trim strip/insert is not projected into the motor vehicle (no particle flight).

Embodiments of the invention are described in more detail below.

Motor vehicle doors are often provided with inserts and/or trim strips on their inside of the door facing the interior of the motor vehicle. These inserts and/or trim strips are made from a plastic and are often provided on the outside with a metallic shiny surface or a coloring that mimics a flesh grain.

If such a motor vehicle door is subjected to a considerable impact force, as can occur in the case of motor vehicle gaps when another motor vehicle hits the outside or the motor vehicle is thrown against a tree, the motor vehicle door is bent and the insert/trim strip is subjected to a breaking force.

In order to prevent breakage, the insert/trim strip has a reinforcement arranged in or on the plastic of the insert/trim strip, which reinforcement consists of a textile, a metal profile, a metal foil, a plastic profile or a plastic film. The textile is a woven or knitted fabric made of plastic, metal or glass fibre.

The reinforcement is mounted on or embedded in the plastic of the rear side of the insert/trim strip facing the door surface. The reinforcement is preferably overmolded by the plastic of the insert/trim strip.

1. A motor-vehicle door insert or trim strip of an inner motor-vehicle door panel, wherein the insert or the trim strip is provided with a reinforcement in or on plastic of the insert or of the trim strip, constituted by a textile, a metal profile, a metal foil, a plastic profile or a plastic film.

2. The trim strip according to claim 1, wherein the textile is a woven or knitted fabric made of plastic, metal or glass fiber.

3. The trim strip according to claim 1, wherein the reinforcement is mounted on or embedded in the plastic.

4. The insert, for example, the trim strip according to claim 1, wherein the reinforcement is mounted on or embedded in the plastic of a rear side of the insert or the trim strip facing the respective motor-vehicle door.

5. The insert, for example, the trim strip according to claim 1, wherein the reinforcement is overmolded by the plastic.
